(19) United States
(12) Patent Application Publication
(10) Pub. No.: US 2019/0107926 A1
(43) Pub. Date: Apr. 11, 2019

(54) INFORMATION PROCESSING APPARATUS AND INFORMATION PROCESSING SYSTEM

(71) Applicant: SHARP KABUSHIKI KAISHA, Sakai City (JP)

(72) Inventors: TAKASHI SAWANO, Sakai City (JP); MAYUKO YOSHIDA, Sakai City (JP); KUMIKO OGINO, Sakai City (JP); YASUHIRO NAKAI, Sakai City (JP); MASAO SAEDA, Sakai City (JP)

(21) Appl. No.: 16/147,749

(22) Filed: Sep. 30, 2018

(30) Foreign Application Priority Data
Oct. 10, 2017 (JP) 2017-196558

(51) Int. Cl. G06F 3/0482; G06F 3/0481; H04N 1/00

(52) U.S. Cl. CPC G06F 3/0482; G06F 3/04817; G06F 3/0488; H04N 1/00413; H04N 1/00474

(57) ABSTRACT

An information processing apparatus includes a display. A home screen including a plurality of icons is displayed on the display, or second screens are displayed on the display. The second screens are displayed when any of the plurality of icons is selected by an operation performed by a user. Each of the plurality of icons displayed on the home screen includes a first area to which a color different from colors applied to the rest of the plurality of icons is applied. Each of the second screens includes a second area to which a color the same as the color applied to the first area included in a corresponding one of the plurality of icons is applied.

### BACKGROUND

### 1. Field

The present disclosure relates to information processing apparatuses and information processing systems and, more specifically, to an information processing apparatus and an information processing system which are configured to perform a plurality of functions.

### 2. Description of the Related Art

An example of the related art is disclosed in Japanese Unexamined Patent Application Publication No. 2016-206926. An image forming apparatus of the related art includes a display and is configured to receive a user's operation via a graphical user interface (GUI) displayed on the display. A main menu screen is displayed on the display. The main menu screen includes buttons assigned to respective functions of the image forming apparatus. Examples of the functions include copy, fax, and scan. When any of the buttons in the main menu screen is selected, a submenu screen is displayed on the display. The submenu screen includes contents about a function corresponding to the button thus selected. In the submenu screen, specific settings are performed, and each of the functions is executed by the image forming apparatus.

### SUMMARY

In the image forming apparatus of the related art, however, a button which is not a button intended by a user may be pressed due to an erroneous operation performed on the main menu screen. Moreover, even when a display on the display is switched to a submenu screen, a user may not notice the erroneous operation and proceed to a subsequent operation on the submenu screen.

Thus, an aspect of the present disclosure is to provide a novel information processing apparatus and an information processing system.

Another aspect of the present disclosure is to provide an information processing apparatus and an information processing system which are configured to improve the viewability of a GUI displayed on a display and reduce erroneous operations.

A first disclosure is an information processing apparatus configured to perform a plurality of functions and including a display. The display is configured to switchably display a first screen and a plurality of second screens. The first screen includes a plurality of icons each assigned to a corresponding one of the plurality of functions. The plurality of second screens each correspond to a corresponding one of the plurality of icons. Each of the plurality of icons includes a first area to which a color different from colors applied to a rest of the plurality of icons is applied. Each of the plurality of second screens includes a second area to which a color the same as the color applied to the first area included in the corresponding one of the plurality of icons is applied.

A second disclosure of the present disclosure is an information processing system including the information processing apparatus according to the first disclosure and an image forming apparatus configured to communicate with the information processing apparatus, wherein at least one of the plurality of functions is executed by cooperation of the information processing apparatus and the image forming apparatus.

The above-described aspects, other aspects, features, and advantages of the present disclosure will further be clarified from the following embodiments descried in detail with reference to the drawings.

### BRIEF DESCRIPTION OF THE DRAWINGS

FIG. 1 is a view illustrating an appearance of an information processing system as an embodiment of the present disclosure;

FIG. 2 is a block diagram illustrating an electrical structure of the information processing apparatus of FIG. 1;

FIG. 3 is a block diagram illustrating an electrical structure of an image forming apparatus of FIG. 1;

FIG. 4 is a view illustrating an example of a home screen;

FIG. 5 is a view illustrating an example of a copy setting screen;

FIG. 6 is a view illustrating an example of the copy setting screen;

FIG. 7 is a view illustrating an example of a detailed setting screen;

FIG. 8 is a view illustrating an example of a confirmation screen;

FIG. 9 is a view illustrating an example of a scan setting screen;

FIG. 10 is a view illustrating an example of a detailed setting screen;

FIG. 11 is a view illustrating a color circle of a second embodiment;

FIG. 12 is a view illustrating an example of a color setting table of a third embodiment; and

FIG. 13 is a view illustrating an example of a home screen of the third embodiment.

### DESCRIPTION OF THE EMBODIMENTS

### First Embodiment

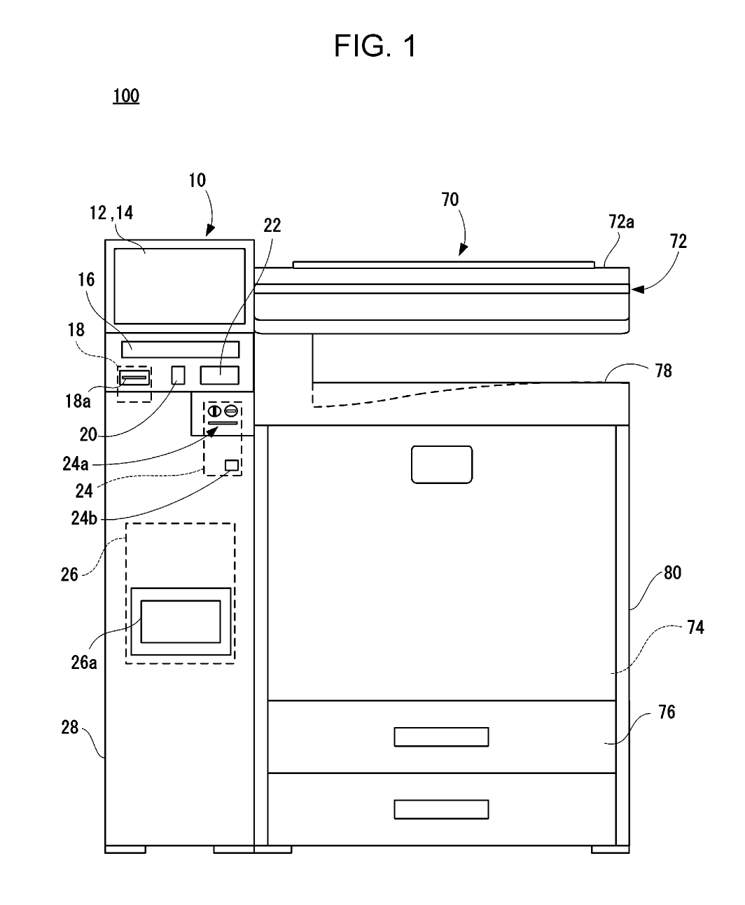

FIG. 1 is a view illustrating an example configuration of an information processing system 100 of the present disclosure. In FIG. 1, the information processing system 100 as a first embodiment of the present disclosure includes an information processing apparatus 10 and an image forming apparatus 70.

The information processing apparatus 10 is a multimedia kiosk (MMK) terminal disposed in a retail establishment such as a supermarket, a restaurant, or a convenience store, or a public facility such as a station, a bus terminal, an airport, an administrative institution, or a library. The information processing apparatus 10 provides a user with various types of information or prescribed services depending on locations where the information processing apparatus 10 is disposed. Moreover, the information processing apparatus 10 may cooperate with the image forming apparatus 70 to provide a user with prescribed services such as copy, print, scan, and fax. This will be described later in detail.

Note that in this specification, a front-back direction (a depth direction) as for the information processing apparatus 10 and its components is defined on the assumption that a surface opposite to a standing position of a user, that is, a surface in a side provided with a display 14 which will be described later is a front surface (a front side), and a left-right direction (a lateral direction) as for the information processing apparatus 10 and its components is defined on the basis of a state where the information processing apparatus 10 is viewed from the user. This applies also to the image forming apparatus 70.

The information processing apparatus 10 includes an apparatus body 28 including the display 14 provided with a touch panel 12, a recording medium connection unit 16, a paper-strip printer 18, a code reading unit 20, a near field communication unit 22, a money processing unit 24, and a photographic printer 26.

The display 14 provided with the touch panel 12 is disposed at an upper end of the information processing apparatus 10 (the apparatus body 28). The touch panel 12 is a universal touch panel, and as the touch panel 12, a touch screen in any system, for example, a capacitive touch panel, an electromagnetic induction touch panel, a resistive film touch panel, an infrared touch panel, or the like may be used. In the first embodiment, a capacitive touch panel is used as the touch panel 12. The touch panel 12 is provided on a display surface of the display 14. Note that a touch panel display in which the touch panel 12 and the display 4 are integrally formed may be employed. Moreover, as the display 14, for example, an LCD display or an electro-luminescence (EL) display may be used.

The recording medium connection unit 16 includes mounting units (for example, a drive and a memory slot) for mounting various types of recording media. Examples of the various types of recording media include optical disks (for example, CD-R, DVD-R, and BD-R) and flash memory (for example, USB memory, SD memory cards, and memory sticks). Note that an optical disk is to be inserted into the drive. Moreover, a flash memory is to be inserted into the memory slot.

The paper-strip printer 18 is, for example, a thermal printer or a dot impact printer and issues a receipt, a journal, or a paper strip on which an image such as a coupon ticket is printed. Specifically, the paper-strip printer 18 prints various types of character strings, images, code patterns (e.g., bar codes), and the like on roll paper and discharges printed paper strips from a paper discharge unit 18a.

The code reading unit 20 includes, for example, a laser scanner or a camera and is configured to read, for example, codes added to products, cards, receipts, and the like or codes displayed on a screen of a user terminal (a portable terminal). Examples of codes readable by the code reading unit 20 include bar codes (one-dimensional bar codes) or two-dimensional codes (for example, QR codes (registered trademark), micro QR codes, DataMATRIX, MaxiCODE, and VeriCODE).

The near field communication unit 22 is, for example, configured to perform wireless, contactless data communication with an IC card (such as an identification card, a membership card, or an employee identification card) or a communication target such as a user terminal in accordance with a communication standard such as ISO/IEC 18092 (a so called near field communication (NFC)). The communicable distance of the near field communication unit 22 is about several centimeters to several meters. The near field communication unit 22 transmits a signal instructing reading of data stored in the communication target (a read command) to the communication target. In response to the read command, the communication target transmits desired data to the near field communication unit 22. The near field communication unit 22 further transmits, together with data to be written in the communication target (write data), a signal instructing writing of the data (a write command). In accordance with the write command, the communication. target writes (stores) the write data thus received to a storage unit of the communication target.

The money processing unit 24 includes a money input unit 24a and a coin return port 24b. The money input unit 24a includes a coin input port, a banknote input port, a change return lever, and the like and is arranged under the near field communication unit 22. Coins input to the coin input port and banknotes input to the banknote input port are sorted based on kinds thereof and are stored in a prescribed money storage unit (not shown). The money storage unit includes coin storage units and banknote storage units. When a coin or a banknote is input, the amount of input money is calculated in accordance with the kinds and the number of coins to be stored in the coin storage unit and the kinds and the number of banknotes to be stored in the banknote storage unit. When prescribed services and the like are performed by the information processing apparatus 10, cost corresponding to the content of the services is subtracted from the amount of the input money to calculate the balance of the amount of the input money. Moreover, when the change return lever is manipulated, coins or banknotes are returned in accordance with the balance of the amount of the input money. Note that coins are returned from the coin return port 24b provided under the money input unit 24a, and banknotes are returned from the banknote input port.

The photographic printer 26 is, for example, a dye-sublimation printer or an ink-jet printer and prints an image onto a paper sheet for photographs (a photographic paper sheet). A photograph printed by the photographic printer 26 is discharged from a discharge unit 26a. Note that as image data for forming the image onto the paper sheet, image data stored in a recording medium connected to the recording medium connection unit 16, image data transmitted from an external computer, or the like is used. Moreover, examples of the size of a photograph printed by the photographic printer 26 include 89 mm×127 mm, 100 mm×148 mm, 127 mm×178 mm, and the like.

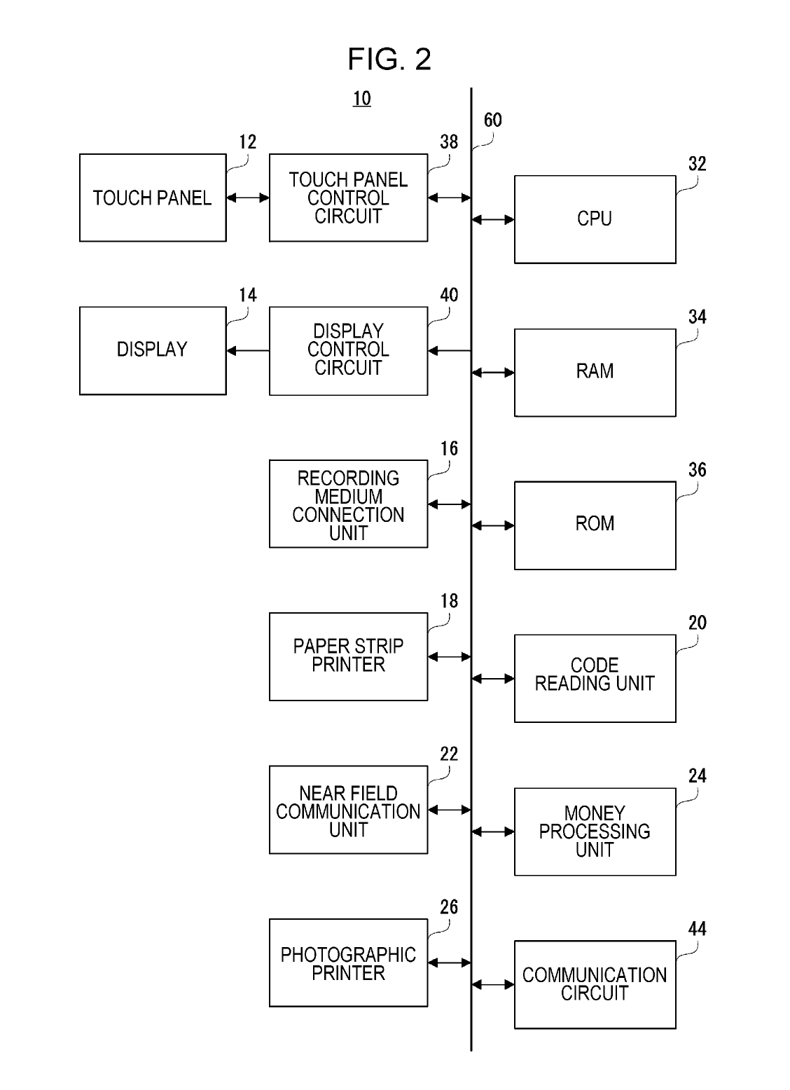

FIG. 2 is a block diagram illustrating an electrical structure of the information processing apparatus 10 of FIG. 1. In FIG. 2, the information processing apparatus 10 includes a CPU 32. The CPU 32 is connected, via a bus 60, to RAM 34, ROM 36, a touch panel control circuit 38, a display control circuit 40, the recording medium connection unit 16, the paper-strip printer 18, the code reading unit 20, the near field communication unit 22, the money processing unit 24, the photographic printer 26, and a communication circuit 44. Moreover, the touch panel 12 is connected to the touch and control circuit 38, and the display 14 is connected to the display control circuit 40.

The CPU 32 is in charge of overall control of the information processing apparatus 10. The RAM 34 is used as a working area and a buffer area for the CPU 32. The ROM 36 stores a startup program of the information processing apparatus 10 and/or default values of various types of information.

The touch panel control circuit 38 gives a voltage or the like to the touch panel 12 and detects a touch operation (a touch input) in a touch effective area of the touch panel 12 to output touch coordinate data denoting the location of the touch input to the CPU 32.

The display control circuit 40 includes a CPU, VRAM, and the like. Under the direction of the CPU 32, the CPU generates, in the VRAM, display image data for displaying various screens on the display 14 by using image generation data stored in the RAM 34 and outputs, to the display 14, the display image data thus generated.

The communication circuit 44 is a communication circuit for establishing connection with a network such as the Internet. The communication circuit 44 is a wired communication circuit or a wireless communication circuit and communicates with an external computer (an external terminal) such as a server over a network in accordance with an instruction given from the CPU 32. Note that the communication circuit 44 is also capable of performing wired communication or wireless communication (for example, in an infrared system, a WiFi (registered trademark) system, or a Bluetooth (registered trademark) system) directly with the image forming apparatus 70, the user terminal, and the like without using a network.

Note that the electrical structure of the information processing apparatus 10 shown in FIG. 2 is a mere example and is not limited to this example.

Referring back to FIG. 1, the image forming apparatus 70 is a multifunction peripheral (MFP) having a copy function, a printer function, a scanner function, a facsimile function, and the like.

The image forming apparatus 70 includes an apparatus body 80 including an image reading unit 72, an image forming unit 74, a paper feeder apparatus 76, and a paper discharge tray 78. Note that the image forming apparatus 70 is installed in the vicinity of the information processing apparatus 10. For example, the image forming apparatus 70 is provided on the right of the information processing apparatus 10.

The image reading unit 72 includes a document platen made of a transparent material and is accommodated in the apparatus body 80. Above the document platen, a document press cover 72a is openably and closably attached via a hinge or the like.

Moreover, the image reading unit 72 includes a light source, a plurality of mirrors, an imaging lens, line sensor, and the like. The image reading unit 72 exposes a document surface to the light source and guides reflected light reflected off the document surface to the imaging lens by the plurality of mirrors. Then, an image of the reflected light is formed onto a light receiving element of the line sensor by the imaging lens. The line sensor detects the luminance or the chromaticity of the reflected light whose image is formed onto the light receiving element, and the line sensor generates read image data based on the image on the document surface. A charge coupled device (CCD), a contact image sensor (CIS), or the like is used as the line sensor.

The image forming unit 74 is accommodated in the apparatus body 80 and is provided under the image reading unit 72. The image forming unit 74 includes a photoreceptor drum, a charging apparatus, an exposure apparatus, a development apparatus, a transfer apparatus, a fixing apparatus, and the like. The image forming unit 74 forms an image on a recording medium (paper sheet) transported by the paper feeder apparatus 76 or the like by an electrophotographic system and discharges the paper sheet with the image thus formed to the paper discharge tray 78 provided between the image reading unit 72 and the image forming unit 74. Note that image data read by the image reading unit 72, image data transmitted from the information processing apparatus 10, image data transmitted from the external computer, or the like is used as image data for forming the image onto the paper sheet. Moreover, the recording medium is not limited to a sheet made of paper but may be a sheet such as an OHP film other than paper.

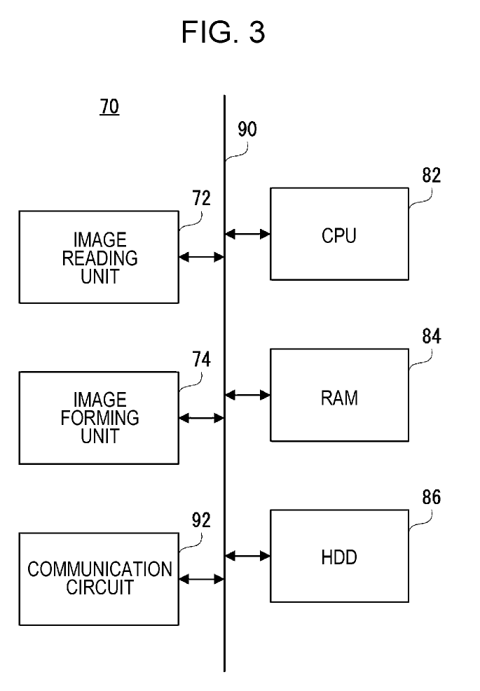

FIG. 3 is a block diagram illustrating an electrical structure of the image forming apparatus 70 shown in FIG. 1. In FIG. 3, the image forming apparatus 70 includes a CPU 82. The CPU 82 is connected, via a bus 90, to RAM 84, HDD 86, the image reading unit 72, the image forming unit 74, and a communication circuit 92.

The CPP 82 is in charge of overall control of the image forming apparatus 70. The RAM 84 is used as a working area and a buffer area of the CPU 82.

The HDD 86 is main memory of the image forming apparatus 70 and accordingly stores a control program based on which the CPU 82 controls operation of each component of the image forming apparatus 70, display image data about various screens, and the like. Note that instead of the HDD 86, or in addition to the HDD 86, other nonvolatile memory such as SSD, flash memory, or EEPROM may be used.

The communication circuit 92 is a communication circuit for establishing connection with a network such as the Internet. The communication circuit 92 is a wired communication circuit or a wireless communication circuit and communicates with an external computer such as a server over a network in accordance with an instruction given from the CPU 82. Note that the communication circuit 92 is also capable of performing wired communication or wireless communication directly with the information processing apparatus 10 without using a network.

Note that the electrical structure of the image forming apparatus 70 shown in FIG. 3 is a mere example and is not limited to this example.

In the information processing system 100 having such a configuration, an operation screen is displayed on the display 14 of the information processing apparatus 10 to receive, in response to a touch input to the touch panel 12, a user's operation. For example, a home screen including a plurality of icons is displayed on the display 14, wherein each of the plurality of icons is assigned to a corresponding one of a plurality of functions executable by the information processing system 100. When any of the icons is selected by the user's operation, a setting screen corresponding to the icon thus selected is displayed on the display 14. In the setting screen, a specific setting is performed, and each function is performed by the information processing apparatus 10 or the image forming apparatus 70.

In a known information processing apparatus, however, an icon different from an icon intended by a user may be erroneously pressed in the home screen due to an erroneous operation. Moreover, even when a display on the display is switched to the setting screen due to the erroneous operation, a user may not notice the erroneous operation and proceed to a subsequent operation on the setting screen.

Thus, in the first embodiment, each of a plurality of icons 112 displayed on a home screen (corresponding to a first screen) 110 includes a first area to which a color different from colors applied to the rest of the plurality of icons 112 is applied. Moreover, a second screen displayed when any one of the icons 112 is selected through an operation performed by a user includes a second area to which a color the same as the color applied to the first area included in the corresponding one of the icons 112 is applied. As used herein, “the same color” means that colors are similar to each other to such an extent that the colors are difficultly distinguishable to the human eye, and the colors are not necessarily exactly the same. Moreover, as used herein, “colors being the same” means that colors have the same hue (color shade), and as long as colors have the same hue, the colors are regarded as the same color even when the colors are different from each other in luminance (brightness).

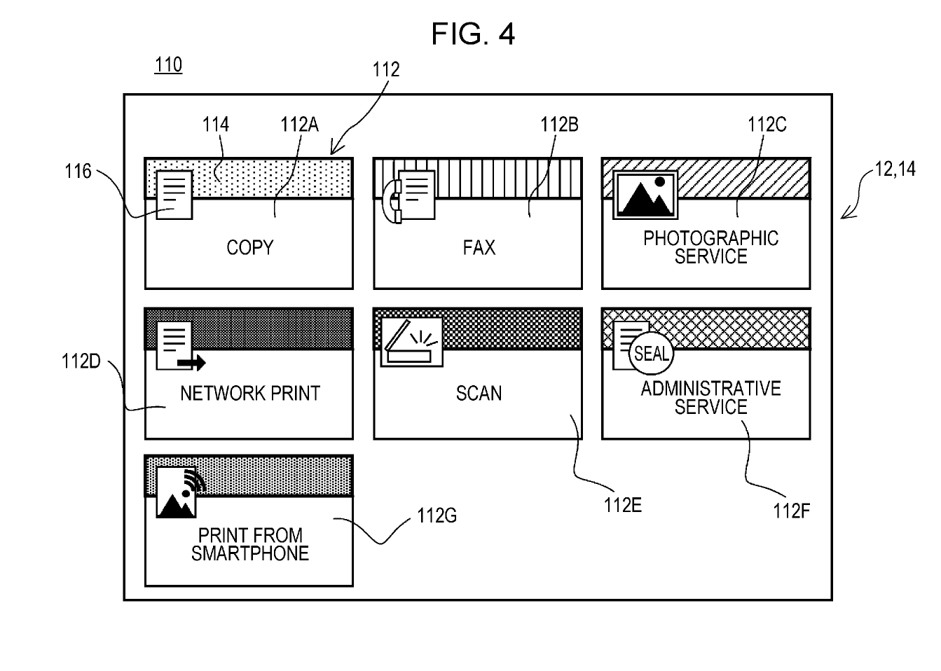

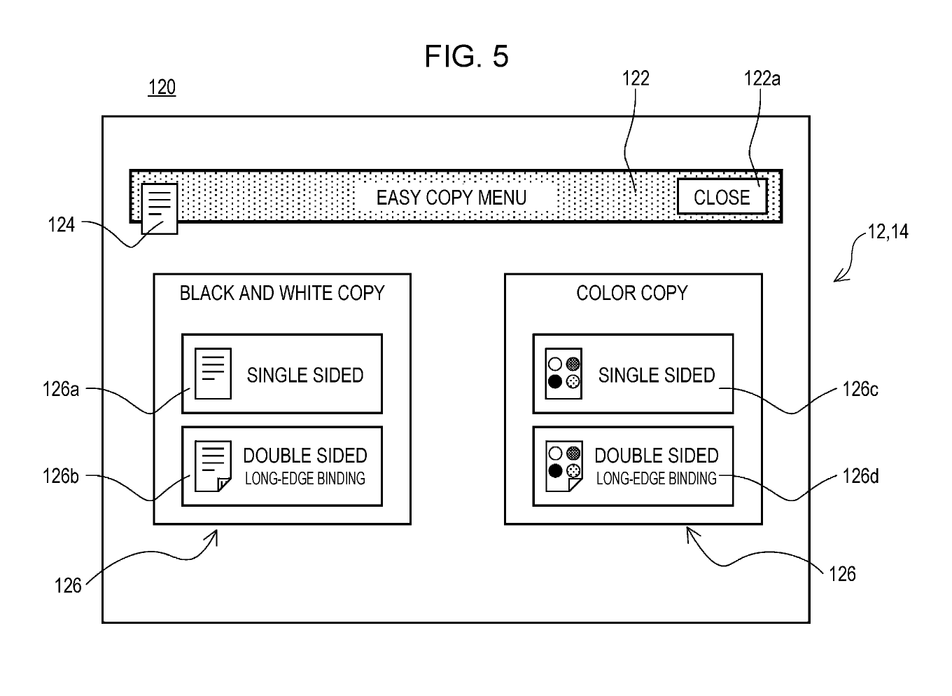

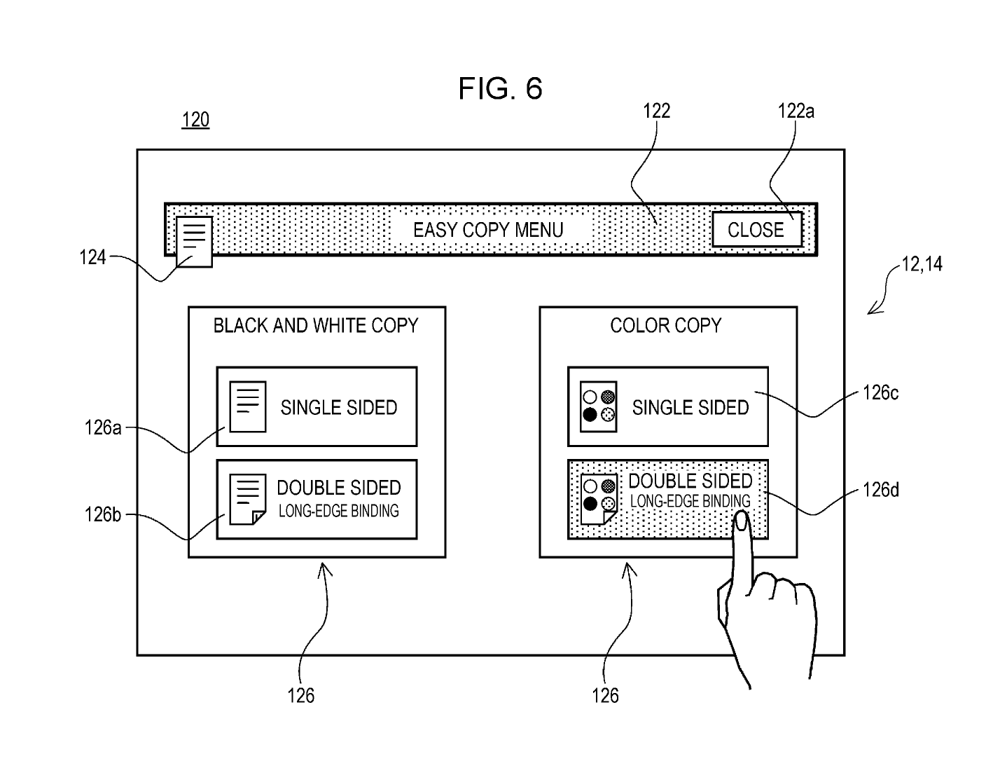

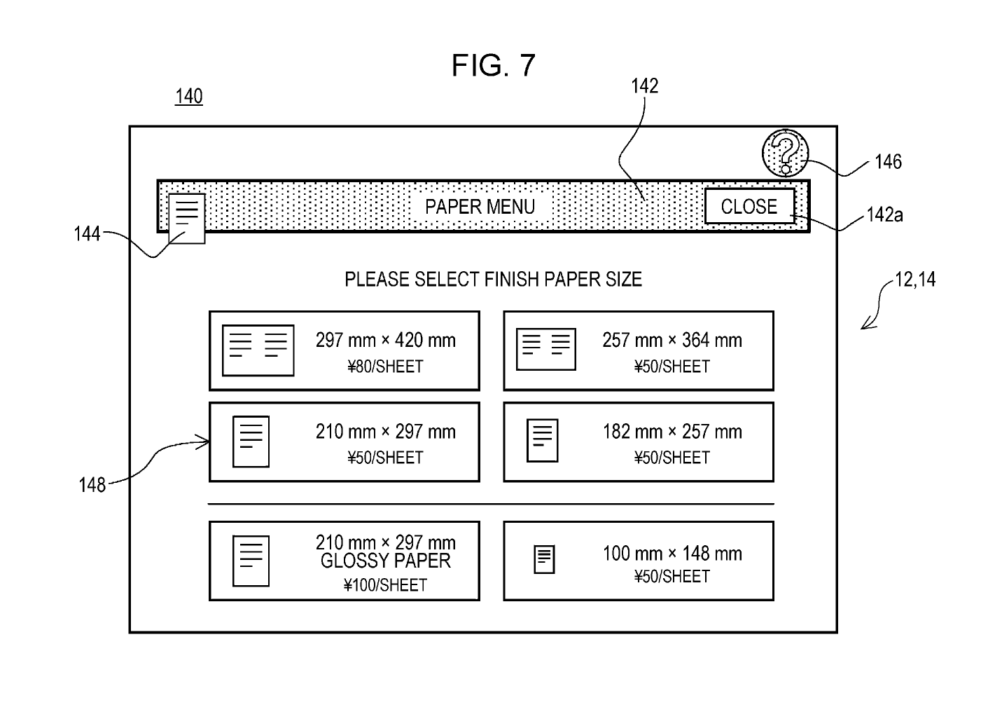

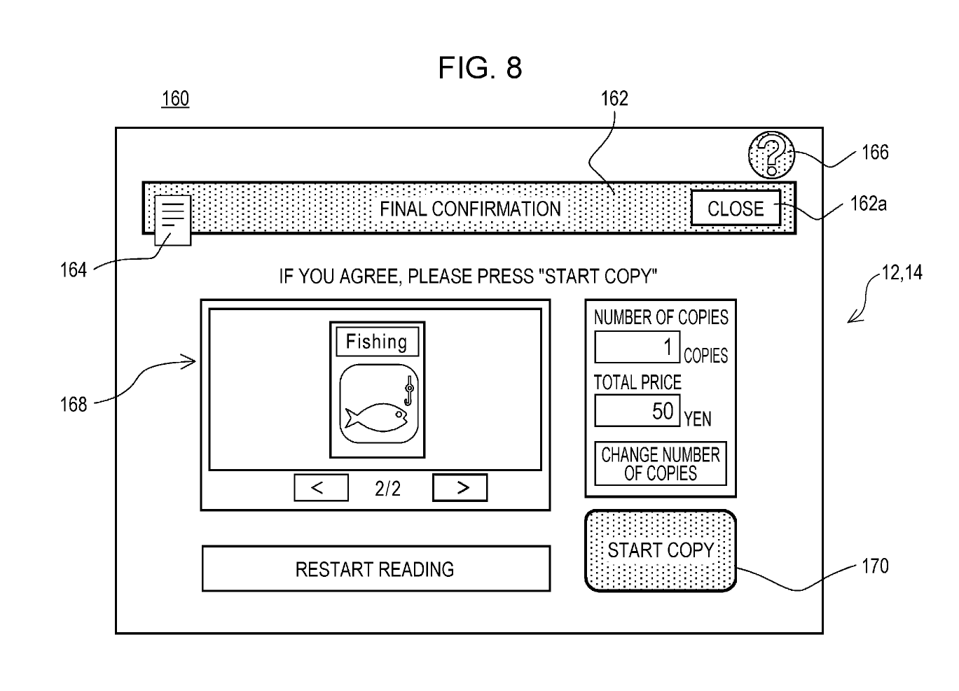

With reference to FIGS. 4 to 8, an example of operation of the information processing system 100 will be described below. FIG. 4 is a view illustrating an example of the home screen 110. FIG. 5 is a view illustrating an example of a copy setting screen 120. FIG. 6 is a view illustrating an example of the copy setting screen 120. FIG. 7 is a view illustrating an example of a detailed setting screen 140. FIG. 8 is a view illustrating an example of a confirmation screen 160.

When main power sources of the information processing apparatus 10 and image forming apparatus 70 are turned on, and the information processing apparatus 10 and image forming apparatus 70 are in stand-by mode in which the information processing apparatus 10 and image forming apparatus 70 are ready for executing respective functions, the home screen 110 as illustrated in FIG. 4 is displayed on the display 14 of the information processing apparatus 10. The home screen 110 is a screen for various jobs to be selected. Note that in the first embodiment, jobs are copy, scan, print, fax transmission, and the like. Images as a plurality of icons 112A to 112G for enabling jobs to be selected are displayed on the home screen 110. To each of the icons 112A to 112G, a job (service) such as copy, fax, photographic service, network print, scan, administrative service, or print from smartphone is assigned. When the icons 112A to 112G are not necessarily distinguished from one another, they are hereinafter simply referred to as “icons 112”.

Each icon 112 is an image surrounded by a substantially rectangular frame and serves as a software key. Each icon 112 includes an area in which a name is displayed (a name display area) and a first area. The name display area is an area in which the name of a function corresponding to the icon is displayed. The name display area is provided at a portion lower than the center in the up-down direction of the icon 112.

The first area is provided at a portion above the name display area, and a prescribed color other than white and black is applied to the first area. Note that the color applied to the first area is different from colors applied to the first areas of the rest of the icons 112. That is, the colors applied to the first areas of the icons 112A to 112G are different from each other. Note that each icon 112 does not include the colors applied to the first areas of the rest of the icons 112. Note that each icon 112 may include white or black.

Moreover, the first area includes a tab 114 and a mark image 116. The tab 114 is in a strip form and is provided at the upper portion of each icon 112. The mark image 116 is an image of a figure according to the content of a job corresponding to the icon 112 and is provided at an upper left portion of the icon 112. For example, the mark image 116 is provided to overlap a left end portion of the tab 114 and an upper left portion of the name display area.

When any of the icons 112 included in the home screen 110 is touched (selected), a plurality of setting screens (corresponding to second screens) for enabling a job assigned to the icon 112 to be set are sequentially displayed on the display 14. For example, when the icon 112A to which a copy job is assigned is touched, a copy setting screen 120 as illustrated in FIG. 5 is displayed as a first setting screen which enables a setting concerning the copy job to be performed.

The copy setting screen 120 includes a second area and a setting area 126. The second area includes a tab 122 and a mark image 124. Moreover, to the second area is applied a color the same as the color of the first area of the icon 112 corresponding to the job selected in the home screen 110 (in the example shown in FIG. 5, the icon 112A corresponding to the copy job).

Note that the color applied to the second area is different from colors applied to the first areas of the icons 112 other than the icon 112 corresponding to the job. Moreover, the copy setting screen 120 does not include the colors applied to the first areas of the icons 112 other than the icon 112A corresponding to the copy job. This also applies to the other setting screens (the detailed setting screen 140, the confirmation screen 160, and the like described later).

Similarly to the tab 114, the tab 122 is in a strip form and is arranged at an upper portion of the copy setting screen 120. Thus, it can be said that the arrangement of the tab 114 in the icon 112 and the arrangement of the tab 122 in the copy setting screen 120 (the second screen) are the same (similar). The same applies to tabs 142, 162, 182, and 202 which will be described later. Moreover, in the tab 122, a close icon 122a for closing the copy setting screen 120 is displayed. When the close icon 122a is touched, the copy setting screen 120 is closed (hidden), and the home screen 110 is displayed on the display 14. The same applies to close icons 142a, 162a, 182a, and 202a which will be described later.

The mark image 124 contains an image corresponding to a figure which is the same as the mark image 116 of the corresponding one of the icons 112 (the icon 112A), and the mark image 124 is arranged at an upper left part of the copy setting screen 120. Moreover, the mark image 124 is arranged to overlap a left end portion of the tab 122 and the setting area 126.

As described above, the mark image 116 included in the icon 112 is arranged at the upper left part of the icon 112, and a part of the mark image 116 is arranged to overlap the left end portion of the tab 114. Thus, it can be said that the arrangement of the mark image 116 in the icon 112 and the arrangement of the mark image 124 in the copy setting screen 120 (the second screen) are the same (similar). The same applies to mark images 144, 164, 184, and 204 which will be described later.

That is, it can be said that the icon 112A and the copy setting screen 120 corresponding to the icon 112A are similar to each other based on, for example, the arrangement of the tab 122 and the mark image 124. This applies to the other icons 112 and setting screens corresponding to the other icons 112, although the illustration thereof is omitted.

The setting area 126 is an area for performing a basic setting of the copy job. The basic setting of the copy job includes two types of settings (a black and white copy/color copy setting and a single-sided copy/double-sided copy setting). In the setting area 126, four icons 126a to 126d are displayed. To each of the icons 126a to 126d, a different setting is assigned. Any of the icons 126a to 126d is touched, thereby the basic setting of the copy job is determined.

For example, as illustrated in FIG. 6, touching the icon 126d to which the double-sided color copy setting is assigned determines that the basic setting of the copy job is double-sided color copy. When the basic setting of the copy job is thus determined, a display of the display 4 is switched to a next setting screen. Here, during a period from a timing at which the icon 126d is touched to a timing at which the display is switched to the next setting screen (for example, one second), the icon 126d has the same color as the second area (the color of the first area of the corresponding one of the icons 112).

Then, the basic setting of the copy job is determined in the copy setting screen 120, and the detailed setting screen 140 as illustrated in FIG. 7 is then displayed on the display 14.

The detailed setting screen 140 is a screen for setting, for example, a copy paper sheet and includes a second area and a setting area 148.

The second area in the detailed setting screen 140 includes the ab 142, the mark image 144, and a help icon 146. Thus, to the help icon 146 is applied a color the same as the color of the first area of the corresponding one of the icons 112. This can also be said that a color the same as the colors of the tab 142 and the mark image 144 is applied to the help icon 146.

The help icon 146 is arranged at an upper right portion of the detailed setting screen 140. To the help icon 146, a function of instructing an execution of a help mode such as searching FAQ is assigned. The same applies to help icons 166 and 206 which will be described later.

The setting area 148 is an area for setting the copy paper sheet. In the setting area 146, a plurality of icons are displayed. To the plurality of icons assigned are settings which relate to the copy paper sheet and which are different from each other. Touching any of the plurality of icons determines a setting of the copy paper sheet. When the setting of the copy paper sheet is determined, a display of the display 14 is switched to a next setting screen.

Thus, until the setting of the copy job is completed, a plurality of setting screens for the copy job are sequentially displayed on the display 14, and the setting of the copy job is determined in accordance with user's operations. Then, when the setting of the copy job is completed, and a document is read by the image reading unit 72, the confirmation screen 160 as illustrated in FIG. 8 is displayed on the display 14.

The confirmation screen 160 is a screen for prompting a user to determine whether or not, for example, the copy job is to be executed. The confirmation screen 160 includes a second area, a preview area 168, and the like.

Note that the second area in the detailed setting screen 160 includes the tab 162, the mark image 164, the help icon 166, and a start icon 170. Thus, to the start icon 170 is applied the same color as the first area of the corresponding one of the icons 112. To the start icon 170, a function of instructing an execution of the copy job is assigned. When the start icon 170 is touched, the copy job is executed in accordance with the setting of the copy job.

In the preview area 168, an image of the document read by the image reading unit 72 is displayed. Moreover, although detailed description will be omitted, the confirmation screen 160 is provided with an icon to which a function of instructing restart of reading of the document is assigned, an icon for changing the number of copies, an icon denoting a price, and the like.

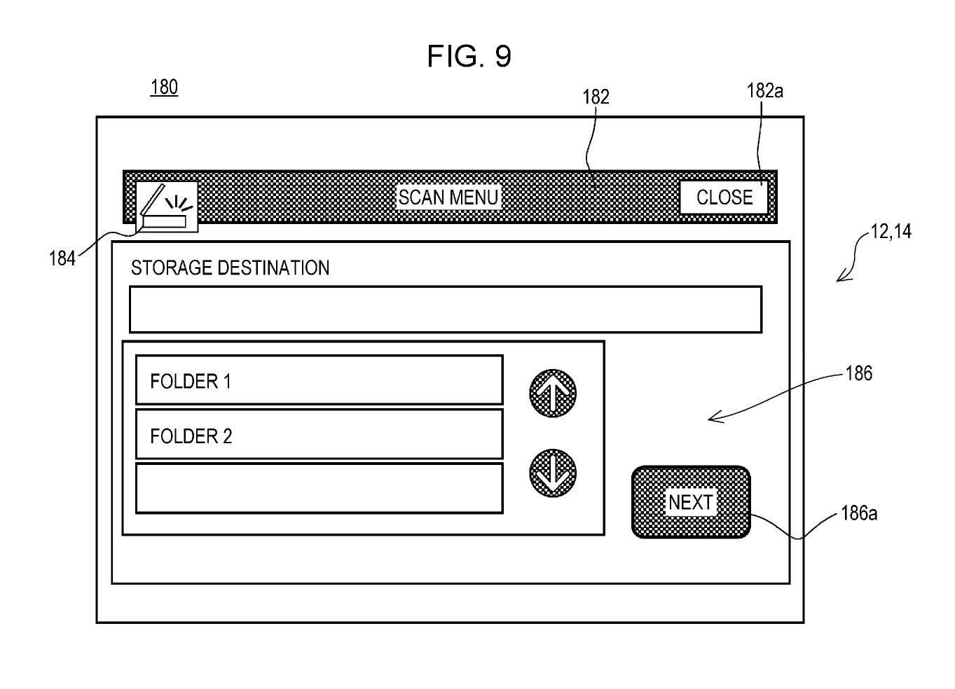

An example of touching the icon 112A to which a copy job is assigned has been described above, and the same applies to a case where another icon 112 is selected. For example, when in the home screen 110 shown in FIG. 5, an icon 112E to which a scan job is assigned is touched, a scan setting screen 180 as shown in FIG. 9 is displayed on the display 14.

The scan setting screen 180 includes the tab 182, the mark image 184, and a setting area 186.

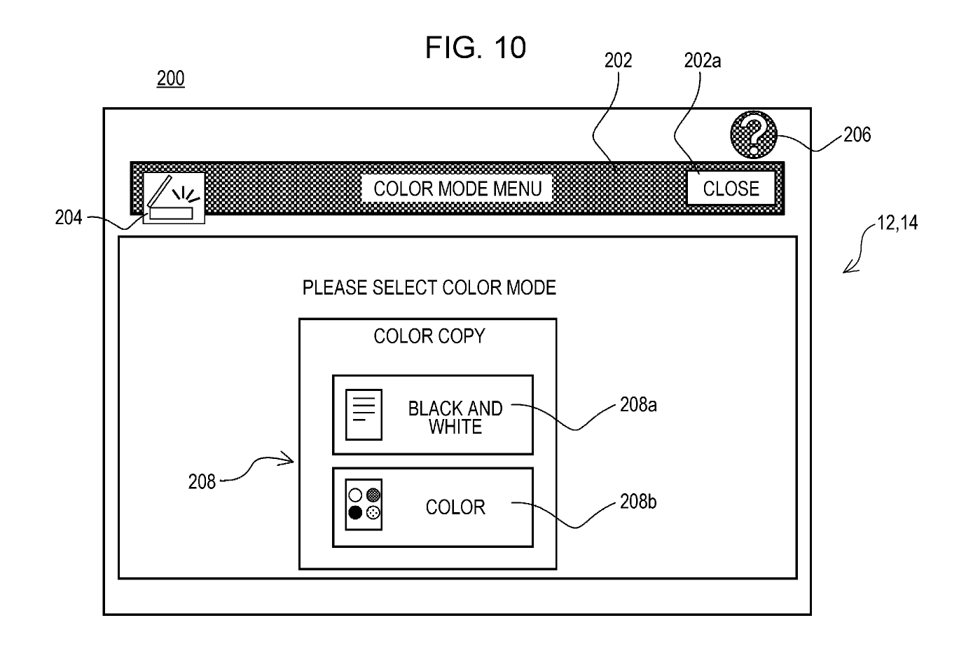

The setting area 186 is an area for setting a storage destination of the read image data which is scanned. In the setting area 186, an icon 186a for proceeding to a next setting screen is displayed. When the storage destination of the read image data is determined, and the icon 186a is touched, a display of the display 14 is switched to a next setting screen. For example, a detailed setting screen 200 as illustrated in FIG. 10 is displayed on the display 14.

Note that a second area in the scan setting screen 180 includes the tab 182, the mark image 184, and the icon 186a. Thus, to the tab 182, the mark image 184, and the icon 186a are applied a color the same as the color of the first area of the corresponding one of the icons 112 (in the example shoran in FIG. 9, the icon 112E).

Similarly to the detailed setting screen 140, the scan setting screen 180, and the like, the detailed setting screen 200 includes a second area (the tab 202, the mark image 204, and the help icon 206), the setting area 208, and the like.

Thus, until the setting of the scan job is completed, setting screens for the scan job are sequentially displayed on the display 14, and the setting of the scan job is determined in accordance with user's operations. Although not shown, when the setting of the scan job is completed, a confirmation screen is displayed on the display 14 in the same manner as in the case of the copy job.

In the first embodiment, each of the plurality of icons 112 displayed on the home screen 110 includes a first area to which a color different from colors of the rest of the plurality of icons 112 is applied, and a setting screen for a job assigned to the icon 112 includes a second area to which a color the same as the color applied to the first area included in the icon 112 is applied. Thus, it is possible to improve the viewability of the GUI displayed on the display 14 and to reduce erroneous operations.

Moreover, according to the first embodiment, each of the plurality of icons 112 displayed on the home screen 110 does not include colors applied to the first areas of the rest of the plurality of icons 112. Therefore, each of the plurality of icons 112 becomes easily identifiable, which enables the erroneous operation to be more appropriately reduced.

Moreover, in the first example, each setting screen does not include colors applied to the first areas of the icons 112 other than the icon 112 corresponding to the job selected in the home screen 110. Thus, when a user erroneously selects an icon 112 other than an icon 112 intended in the home screen 110, the color included in each setting screen makes the erroneous operation noticeable, which enables the erroneous operation to be more appropriately reduced.

Furthermore, according to the first embodiment, each of the plurality of icons 112 displayed on the home screen 110 may include the mark image 116 corresponding to the content of the job corresponding to the icon 112. Thus, a function assigned to each of the plurality of icons 112 becomes easily recognizable, which enables the erroneous operation to be more appropriately reduced.

Moreover, to the mark image 116 may be applied a color the same as the color of the tab 114 of the icon 112 in which the mark image 116 is included. Thus, each of the plurality of icons 112 becomes easily identifiable, which enables the erroneous operation to be more appropriately reduced.

### Second Embodiment

An information processing apparatus 10 of a second embodiment is the same as the first embodiment except that a plurality of icons 112 are classified into groups, and similar colors are applied to first areas of the icons 112 belonging to an identical group of the groups. Therefore, contents different from those of the first embodiment will be described, and duplicate description will be omitted.

In the second embodiment, the plurality of icons 112 as shown in FIG. 4 are classified into groups in accordance with functions corresponding to the icons 112.

For example, the plurality of icons 112 are classified into a group (first group) for performing printing, a group (second group) for scanning documents, and a group (third group) for performing prescribed services.

An icon 112A corresponding to “copy”, an icon 112D corresponding to “network print”, and an icon 112G corresponding to “printing from smartphone” are classified into the first group for performing printing.

An icon 112B corresponding to “fax” and an icon 112E corresponding to “scan” are classified into the second group for scanning documents.

An icon 112C corresponding to “photographic service” and an icon 112F corresponding to “administrative service” are classified into the third group for performing prescribed services.

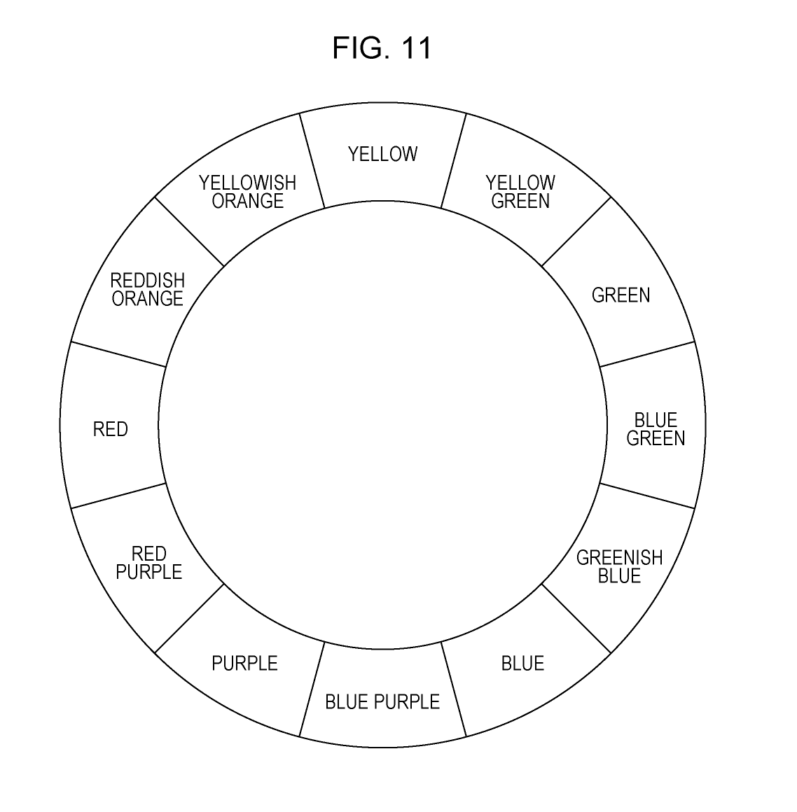

Then, similar colors are applied to the first areas of the icons 112 belonging to an identical group. As mentioned herein, “similar colors” means colors adjacent to a target color in the color circle shown in FIG. 11. For example, as shown in FIG. 11, similar colors of yellow are yellow green and yellowish orange.

It can be said that similar colors are applied to the first areas of the icons 112 belonging to the first group, similar colors are applied to the first areas of the icons 112 belonging to the second group, and similar colors are applied to the first areas of the icons 112 belonging to the third group. For example, in the first group, the first area of the icon 112A is colored in blue, the first; area of the icon 112D is colored in blue-green, and the first area of the icon 1120 is colored in greenish blue. As can be seen from the color circle shown in FIG. 11, blue-green, blue, and greenish blue are similar colors.

Moreover, in the second group, the first area of the icon 112B is colored in red, and the first area of the icon 112E is colored in red-purple which is a similar color to red. Furthermore, in the third group, the first area of the icon 112C is colored in yellow, and the first area of the icon 112F is colored in yellowish orange which is a similar color to yellow.

According to the second embodiment, the plurality of icons 112 may be classified into groups, and similar colors may be applied to the first areas of the icons 112 belonging to an identical group of the groups. Therefore, a function assigned to each of the plurality of icons 112 becomes easily recognisable, which enables the erroneous operation to be more appropriately reduced.

Moreover, according to the second embodiment, to the first area of the icon 112 is applied a color different from colors applied to the first areas of the icons 112 belonging to the other groups. Therefore, each of the plurality of icons 112 becomes easily recognizable, which enables the erroneous operation to be more appropriately reduced.

Note that, in the second embodiment, the plurality of icons 112 are classified into three groups in accordance with the functions, but the second embodiment is not necessarily limited to this example. For example, the plurality of icons 112 may be classified into two groups depending on whether or not the icons have a function. Alternatively, the plurality of icons 112 may be classified into four or more groups.

Moreover, in the second embodiment, the plurality of icons 112 are classified depending on whether or not they have functions of printing, scanning, and providing prescribed services, but the second embodiment is not necessarily limited to this example. For example, the plurality of icons 112 may be classified depending on whether or not the plurality of icons 112 communicate with the outside, or whether or not the plurality of icons 112 perform user authentication. As described above, the functions depending on which the plurality of icons 112 are classified are accordingly changeable.

Moreover, the colors applied to the first areas of the icons 112 belonging to each group described in the second embodiment are mere examples, and the colors are not limited to these examples. As long as the icons 112 belonging to the groups are identifiable, the colors applied to the first areas of the icons 112 belonging to each group are accordingly changeable.

Moreover, the second embodiment has been described with reference to the color circle including 12 colors shown in FIG. 11, but the color circle including 24 colors may be used. In this case, similar colors are not limited to colors adjacent to a target color. For example, colors located within 90° from the target color as the center nay be defined as similar colors.

### Third Embodiment

An information processing apparatus 10 of a third embodiment is the same as that of the first embodiment except that a color to be applied to a tab 114 is set in accordance with operation of an information processing apparatus 10 or an image forming apparatus 70 included in a function. corresponding to the icon 112. Therefore, contents different from those of the first embodiment will be described, and duplicate description will be omitted.

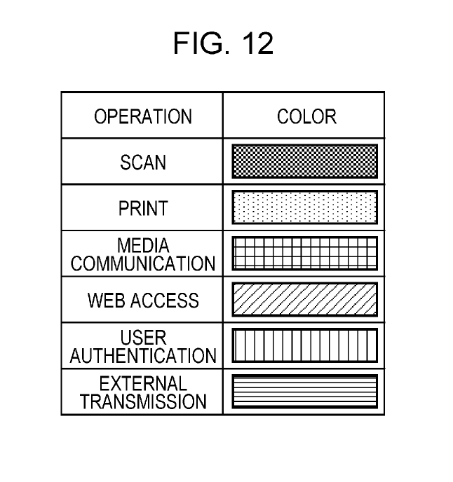

FIG. 12 is a view illustrating an example of a color setting table of the third embodiment. As illustrated in FIG. 12, the color setting table denotes colors correspondingly to the names of operations of the image forming apparatus 70. Data of the color setting table is stored in RAM 84 (see FIG. 2).

In the example of the color setting table shown in FIG. 12, the names of operations such as scan, print, media communication, WEB access, user authentication, and external communication are described in the field of the names of operations of the image forming apparatus 70.

Note that contents described in the field of the names of operations of the image forming apparatus 70 are merely created and used by internal processes in the image forming apparatus 70. Thus, as long as operations are identifiable, the names of operations may be numerical digits or signs which are unreadable by humans.

Moreover, in the field of the color, characters representing the colors according to the names of operation of the image forming apparatus 70 are denoted. Note that for each operation of the image forming apparatus 70, a different color is set.

As used herein, “scan” means an operation of reading a document by an image reading unit 72 to generate read image data.

As used herein, “print” means an operation of forming (printing) an image onto a paper sheet by an image forming unit 74.

As used herein, “media communication” means operations of communicating with various recording media such as a user terminal, an SD card, or USB memory to read data from the recording medium and write data to the recording medium. Note that when communication with the user terminal is performed, transmission and reception of data between the image forming apparatus 70 and the user terminal may be performed by wireless communication, for example, in an infrared system, a Bluetooth (registered trademark) system, or a near field communication (NEC) system.

As used herein, “WEB access” means an operation of communicating with an external computer such as a server over a network to read data from the external computer and to write data to the external computer.

As used herein, “user authentication” means an operation of identifying a user by The image forming apparatus 70. For example, when the user authentication is executed, a user is requested to, for example, input a user ID and a password in order to specify the user.

As used herein “external communication” means an operation of transmitting the read image data to the external terminal and receiving image data transmitted from the external terminal by facsimile communication. Note that the “external communication” does not involve an operation of transmitting and receiving data over a network.

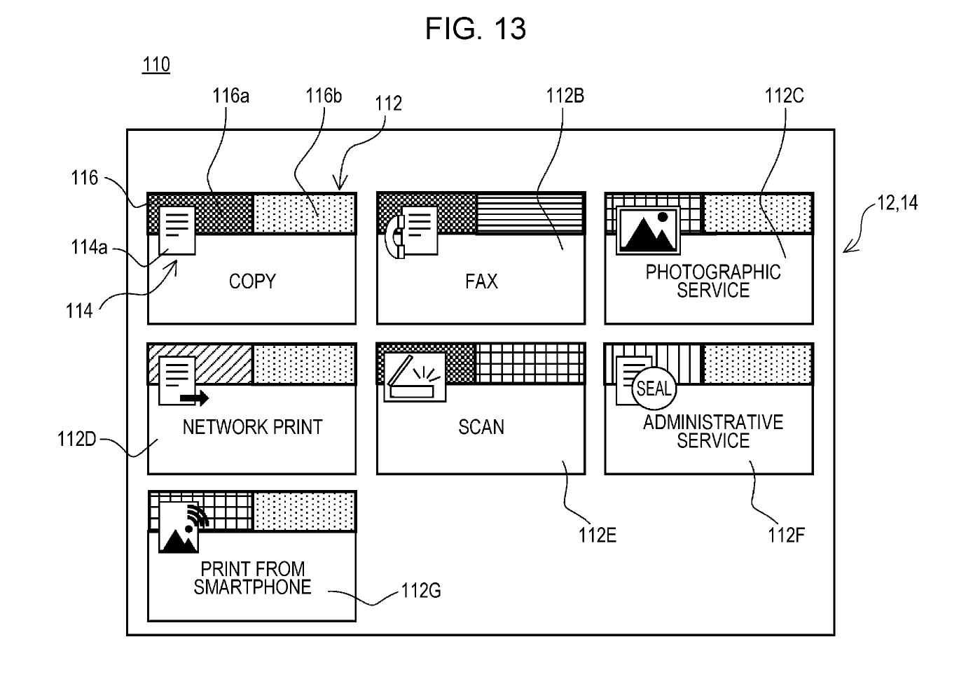

FIG. 13 is a view illustrating an example of a home screen 110 of the third embodiment. As illustrated in FIG. 13, in accordance with a color setting table, a color to be applied to the tab 114 is set in accordance with the operation of the image forming apparatus 70 included in the function corresponding to the icon 112.

For example, two colors corresponding to operations, namely, scan and print are applied to a tab 114 of an icon 112A to which a copy job is assigned. This is because the copy job includes two operations, namely, scan and print.

Note that in the tab 114, of operations included in the functions corresponding to the icon 112, a color corresponding to an operation which is performed first is arranged on the left, and a color corresponding to an operation performed later is arranged on the right. For example, in the case of the copy job, after a document is scanned, printing is performed in accordance with the read image data thus scanned, and therefore, a color corresponding to an is arranged on the left, and a color corresponding to print is arranged on the right.

Similarly to the on 112A, two colors are applied to each of the other icons 112 in accordance with operations included in the function corresponding to the icon 112.

According to the third embodiment, a color to be applied to the tab 114 is set in accordance with the operation of the image forming apparatus 70 included in the function corresponding to the icon 112. Thus, it is possible to recognize an operation included in a function assigned to each of the plurality of icons 112. That is, it is possible to recognize contents of a function assigned to each of the plurality of icons 112. This enables the erroneous operation to be appropriately reduced.

Note that specific components and the like mentioned in the above-described embodiments are mere examples and may be accordingly changed in accordance with actual products.

The present disclosure contains subject matter related to that disclosed in Japanese Priority Patent Application JP 2017-196558 filed in the Japan Patent Office on Oct. 10, 2017, the entire contents of which are hereby Incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus configured to perform a plurality of functions, comprising:
a display configured to switchably display a first screen and a plurality of second screens, the first screen including a plurality of icons each assigned to a corresponding one of the plurality of functions, the plurality of second screens each corresponding to a corresponding one of the plurality of icons, wherein
each of the plurality of icons includes a first area to which a color different from colors applied to a rest of the plurality of icons is applied, and
each of the plurality of second screens includes a second area to which a color the same as the color applied to the first area included in the corresponding one of the plurality of icons is applied.

2. The information processing apparatus according to claim 1, wherein
each of the plurality of second screens does not include colors applied to the first areas included in the icons other than the corresponding one of the plurality of icons.

3. The information processing apparatus according to claim 1, wherein
each of the plurality of icons includes a mark corresponding to the function corresponding to each of the plurality of icons, and
each of the plurality of second screens includes a mark corresponding to the mark included in the corresponding one of the plurality of icons.

4. The information processing apparatus according to claim 3, wherein
to the mark included in each of the plurality of second screens is applied a color the same as the color applied to the first area of the corresponding one of the plurality of icons.

5. The information processing apparatus according to claim 1, wherein
each of the plurality of icons and a corresponding one of the plurality of second screens are similar figures.

6. The information processing apparatus according to claim 5, wherein
an arrangement of the first area in each of the plurality of icons is the same as an arrangement of the second area in the corresponding one of the plurality of second screens.

7. The information processing apparatus according to claim 1, wherein
the plurality of icons are classified into groups in accordance with the functions corresponding to the plurality of icons, and
colors applied to the first areas included in the icons belonging to an identical group of the groups are similar colors.

8. An information processing system, comprising:
the information processing apparatus according to claim 1; and
an image forming apparatus configured to communicate with the information processing apparatus, wherein
at least one of the plurality of functions is executed by cooperation of the information processing apparatus and the image forming apparatus.
